(19) United States
(12) Patent Application Publication
(10) Pub. No.: US 2014/0117925 A1
(43) Pub. Date: May 1, 2014

(54) APPARATUS AND METHOD FOR CONNECTING MULTIPLE-VOLTAGE ONBAORD POWER SUPPLY SYSTEMS

(71) Applicants: Ulf Pischke, Stuttgart (DE); Nils Draese, Feuerbach (DE); Sebastian Walenta, Stuttgart (DE)

(72) Inventors: Ulf Pischke, Stuttgart (DE); Nils Draese, Feuerbach (DE); Sebastian Walenta, Stuttgart (DE)

(73) Assignee: ROBERT BOSCH GmbH, Stuttgart (DE)

(21) Appl. No.: 14/126,827

(22) PCT Filed: May 23, 2012
(86) PCT No.: PCT/EP2012/059583

§ 371 Date: Dec. 16, 2013

(30) Foreign Application Priority Data
Jun. 17, 2011 (DE) 10 2011 077 704.0
May 22, 2012 (DE) 10 2012 208 520.3

(51) Int. Cl. H02J 7/00

(52) U.S. Cl. CPC H02J 7/0052
USPC 320/107

(57) ABSTRACT

An apparatus and a method are proposed for connecting multiple-voltage onboard power supply systems, wherein the apparatus comprises at least one DC/DC voltage converter (10) which can couple a first onboard power supply system (12) having a first onboard power supply system voltage (U1) to a second onboard power supply system (14) having a second onboard power supply system voltage (U2), wherein besides the DC/DC voltage converter (10) at least one charging means (18) is provided for increasing the second onboard power supply system voltage (U2).

### BACKGROUND OF THE INVENTION

The invention is based on an apparatus and a method for connecting multiple-voltage onboard power supply systems.

A converter for converting electrical energy is already known from EP 1145416 B1. It is thus proposed here that the reactor size can be reduced through the use of coupled inductors. The coupled reactors are to be sized such that the load currents of the sub-branches compensate each other and do not result in a magnetic loading of the reactor. Only the differential current between the individual sub-branches thus results in a magnetic field.

The object of the present invention is to specify an apparatus and a method for connecting multiple-voltage onboard power supply systems that are characterized by simple circuit design and simple operation.

### SUMMARY OF THE INVENTION

In contrast, the apparatus according to the invention and the method according to the invention for connecting multiple-voltage onboard power supply systems have the advantage that it is possible to charge an energy storage on the primary side via especially simple measures, also in the reverse operation of a DC-DC converter, in particular, a bidirectional reactor step-down converter, even if the voltage on the primary side is lower than the secondary voltage. It is thus possible to omit complex additional measures. According to the invention, it is possible to connect two onboard power supply systems safely and reliably without current spikes, even if the onboard power supply system topologies are different.

In a useful further development, at least one current source, preferably a constant-current source, is provided as a charging means. This implementation is characterized by an especially simple circuit design.

In a useful further development, at least one additional DC-DC converter is provided as a charging means. This DC-DC converter can handle the charging function especially for applications in which it is present in any case.

In a useful further development, the charging means comprises an adjustment means for adjusting a charging current, preferably a Zener diode. It is thus possible to adapt to the respective application case in an especially simple and cost-effective manner.

The method according to the invention for connecting multiple-voltage onboard power supply systems comprises at least one DC-DC converter that is able to connect a first onboard power supply system having a first onboard power supply system voltage to a second onboard power supply system having a second onboard power supply system voltage. At least one charging means charges an intermediate circuit capacitance that is present in the second onboard power supply system to an intermediate voltage before connecting an energy storage to the second onboard power supply system.

In a useful further development, it is provided that when an intermediate voltage is reached, the intermediate circuit capacitance continues to be charged via the DC-DC converter alone or in combination with the charging means.

In a useful further development, at least one protective element located between the second onboard power supply system and the DC-DC converter is activated if the output voltage of the DC-DC converter corresponds approximately to the voltage of the intermediate circuit capacitance. Under these voltage conditions, the DC-DC converter is able to continue to increase the voltage of the second onboard power supply system in so-called reverse operation to the voltage level of the energy storage.

In a useful further development, the charging means is deactivated if the output voltage of the DC-DC converter corresponds approximately to the voltage of the intermediate circuit capacitance. It is thus especially easy to increase the voltage in a controlled manner using only the DC-DC converter.

In a useful further development, the intermediate circuit capacitance is charged via the DC-DC converter alone or in combination with the charging means to a voltage that corresponds approximately to the open-circuit voltage of the energy storage. The connection takes place at nearly equal voltage levels without disruptive current spikes.

In a useful further development, the DC-DC converter increases the voltage of the intermediate circuit capacitance in parallel with the charging means. A targeted disconnection of the charging means can be omitted in the event of a rapid voltage increase.

The described method also provides the option of performing a diagnosis of the intermediate circuit during charging via the charging means. It is thus possible to determine whether a short circuit to ground exists or leakage currents exist. In addition, it is possible to determine which capacitance is present in the intermediate circuit. A diagnosis of the entire second onboard power supply system is also possible. To do this, the voltage in the intermediate circuit could be increased in a targeted manner to a known, non-critical voltage of, for example, 20 V. All control devices and components in the second onboard power supply system are then polled via appropriate bus systems to determine whether they also measure the non-critical voltage of, for example, 20 V. Only then is the voltage increased further and the second onboard power supply system activated.

### BRIEF DESCRIPTION OF THE DRAWINGS

A number of embodiments are illustrated in the figures and are described in detail below.

The following are shown:

FIG. 1 A first onboard power supply system topology for a so-called Boost Recuperation System,

FIG. 2 An onboard power supply system topology having a DC-DC converter and an energy storage implemented as a DLC with a decoupling element between the starter circuit and the consumer onboard power supply system,

FIG. 3 An embodiment having an additional DC-DC converter,

FIG. 4 The implementation in terms of circuitry for connecting the two onboard power supply systems,

FIG. 5 The temporal progression of a first ramp-up scenario for connecting the two onboard power supply systems, and

FIG. 6 The temporal progression of a second ramp-up scenario for connecting the two onboard power supply systems.

### DETAILED DESCRIPTION

In future multiple-voltage onboard power supply systems, DC-DC converters will be used that ensure the transfer of energy between the various onboard power supply system circuits 12, 14 having different voltage levels U1, U2. The DC-DC converter 10 generally constitutes the interface between a conventional consumer onboard power supply system (first onboard power supply system 12) having a first onboard power supply system voltage U1, usually 14 V, and another onboard power supply system circuit (second onboard power supply system 14) having a second onboard power supply system voltage U2 that is higher with respect to the first onboard power supply system voltage U1, for example, 48 V or 60 V.

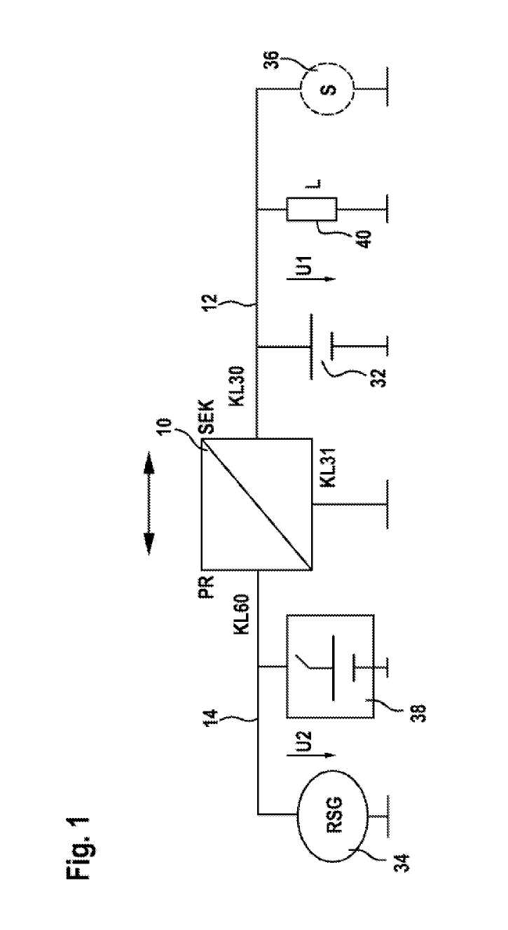

The examples briefly described in FIGS. 1 through 3 are representative of a number of possible onboard power supply system architectures.

FIG. 1 thus shows a so-called Boost Recuperation System having a regenerative generator 34 (RSG) and an energy storage 38 connected in parallel, for example, a 48 V high-performance storage device such as a lithium-ion battery. The generator 34 and energy storage 38 are components of the second onboard power supply system 14 having a second onboard power supply system voltage U2. The first onboard power supply system 12 having the first onboard power supply system voltage U1 of, for example, approximately 12 V or 14 V comprises a starter 36 connected to ground, a load 40 connected in parallel, and a battery 32 also connected in parallel. A DC-DC converter 10 connected to ground connects the first onboard power supply system 12 to a second onboard power supply system 14 having a second onboard power supply system voltage U2 that is higher with respect to the first onboard power supply system voltage U1, for example, of the order of 48 V or 60 V. The generator 38 in a so-called Boost Recuperation System can, for example, feed in electrical energy into the onboard power supply system 14 during braking.

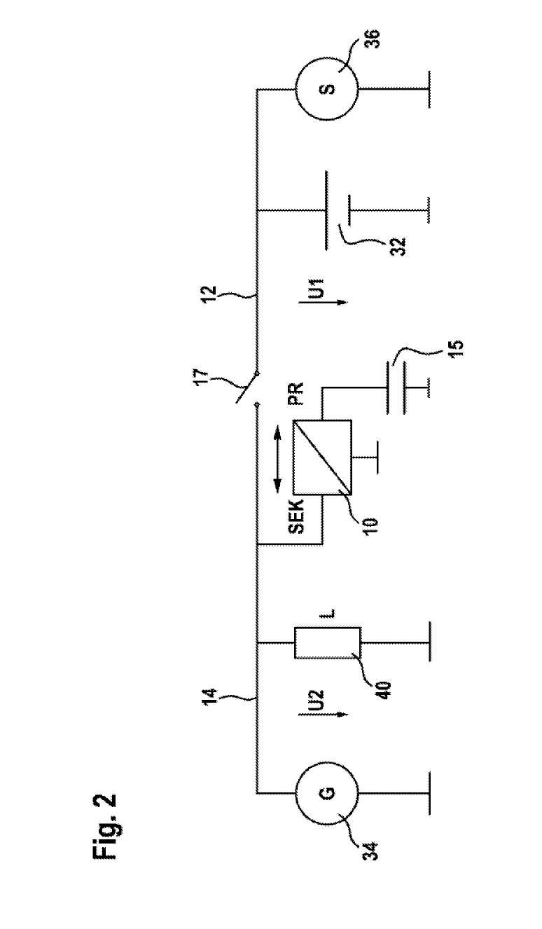

FIG. 2 shows a DC/DC DLC module and a decoupling element between the starter circuit and the consumer onboard power supply system for so-called start-stop coasting (SSC). In the first onboard power supply system 12, the starter 36 and battery 32 are connected in parallel and can be disconnected from the second onboard power supply system 14 via a separation means 17 such as a switch. In the second onboard power supply system 14, a generator 34 and a load 40 are connected in parallel to ground. The second onboard power supply system voltage U2 of the second onboard power supply system 14 is routed to the secondary side of the SEK of the DC-DC converter 10, whereas the primary side PR of the DC-DC converter 10 is connected via a capacitor 15 to ground. The capacitor 15 acts as an energy storage and is, for example, configured as a double-layer capacitor (DLC).

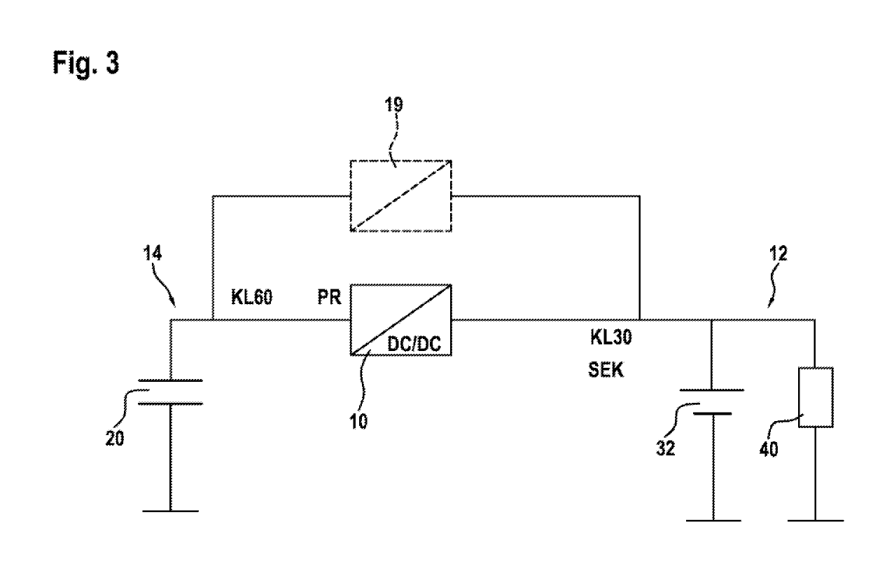

In the topology according to FIG. 3, the DC-DC converter 10 connects a first and a second onboard power supply system 12, 14. In the first onboard power supply system 12, a battery 32 and a load 40 are connected in parallel to ground. In the second onboard power supply system 14, a capacitance 20 is connected to ground. Parallel to the DC-DC converter 10, an additional DC-DC converter 19 connects the two onboard power supply systems 12, 14.

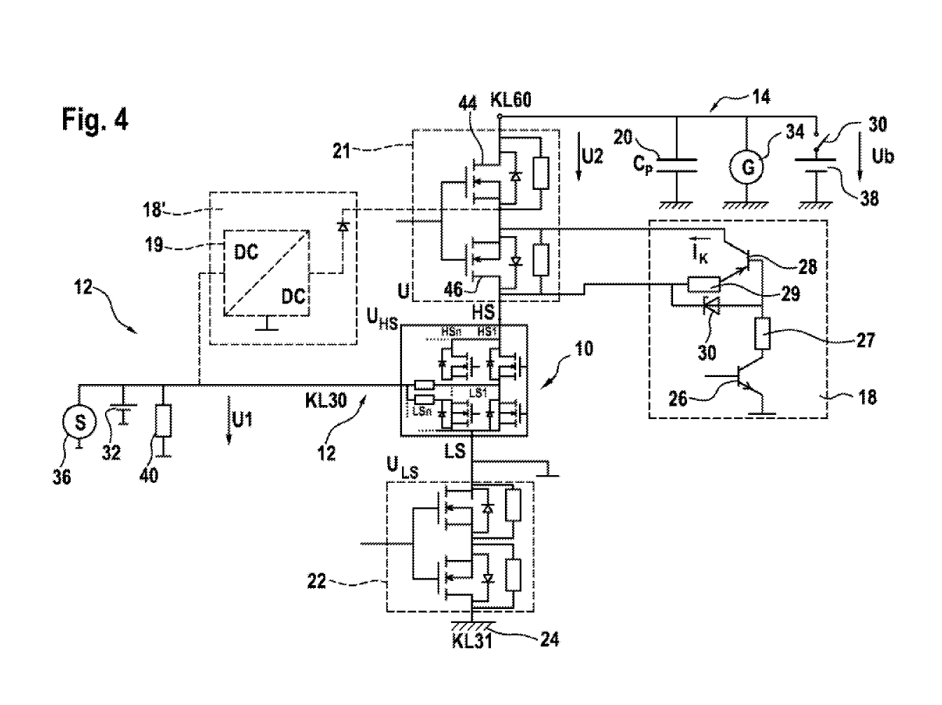

FIG. 4 shows the typical circuit configuration of a bidirectional reactor step-down converter as an example of a DC-DC converter 10 having a first and a second protective element 21, 22 and a charging means 18. The DC-DC converter 10 is configured as an n-phase, bidirectional reactor step-down converter. For this purpose, n MOSFETs HS1 to HSn are connected in parallel on the higher-voltage side HS. Their drain connections are at the same potential and are led out of the DC-DC converter 10 via the terminal HS. Additional MOSFETs LS1 to LSn are connected in series to each MOSFET HS1 to HSn. Their source connections are at the same potential and are led out via the terminal LS and are connected via the second protective element 22 to ground 24 via the terminal KL31. Between the MOSFETs HS1, LS1; HSn, LSn, which are connected in series, the potential is brought into electrical contact, in each case via a reactor and, once merged, via the so-called terminal KL30, with the first onboard power supply system 12.

On the primary side, a first protective element 21 is arranged between the terminal HS of the DC-DC converter 10 and the second onboard power supply system 14. The output of the first protective element 21 is led out as a terminal KL60. The nominal voltage or second onboard power supply system voltage U2 of the second onboard power supply system 14 has a nominal voltage that is higher with respect to the first onboard power supply system voltage U1, for example, 60 V. In the second onboard power supply system 14, the generator 34 and the energy storage 38, for example, a battery, are connected in parallel to ground. The voltage Ub is present at the energy storage 38. The energy storage 38 can be connected via a switch 30 to the second onboard power supply system 14. A schematically drawn intermediate circuit capacitance 20 of the second onboard power supply system 14 results from the capacitances of the consumers or electrical assemblies connected to the second onboard power supply system 14, for example, the generator 34.

The second protective element 22 is provided in the ground path of the DC-DC converter 10. The protective elements 21, 22 are constructed, for example, as switching means such as semiconductor switches, relays, etc. The embodiment relates to two semiconductor switches such as MOSFETs that are connected inversely parallel to each other. An undesired current flow between the first and second onboard power supply systems 12, 14 can thus be safely avoided in the event of a fault, which could occur, for example, via the intrinsic diode of a MOSFET of the DC-DC converter 10. The resistors depicted in the protective elements 21, 22 provide balancing and preferably have high resistance.

The DC-DC converter 10 is connected to the first onboard power supply system 12, which has a first onboard power supply system voltage U1, for example, 12/14 V, via the so-called terminal KL30. By way of example, a starter 36, energy storage 32, and load 40 are connected to the first onboard power supply system 12.

According to FIG. 4, a charging means 18 is provided for charging the intermediate circuit capacitance 20 of the second onboard power supply system 14. The charging means 18 is configured by way of example as a constant current source. For this purpose a first switching means 26 is used, which can be, for example, implemented as a transistor, in the embodiment as an NPN transistor. The base of the second switching means 28, which is implemented in the embodiment as a PNP transistor, is activated via the first switching means 26. The collector of the first transistor 26 is connected via a resistor 27 to the base of the second transistor 28. The desired load current arises at the collector of the second transistor 28 in the form of a constant current Ik. The constant current Ik is supplied to the first protective element 21, namely, between the two power semiconductors, for example, MOSFETs, that are connected inversely parallel to each other. A Zener diode 30 is connected to the base of the second transistor 28 and via another resistor 29 to the emitter of the second transistor 28 as a means of current adjustment. In addition, the Zener diode 30 and the other resistor 29 are electroconductively connected to the output of the DC-DC converter 10 and to the input of the first protective element 21. The Zener diode 30 is in a current feedback loop for adjusting the constant current Ik, which, for example, could shift by the order of approximately 1 A.

As an alternative charging means 18′, another DC-DC converter 19 could be provided between the first onboard power supply system 12 and a first protective element 21 and connected via a diode, which converter in turn is electroconductively connected between the two MOSFETs of the first protective element 21 that are connected in series.

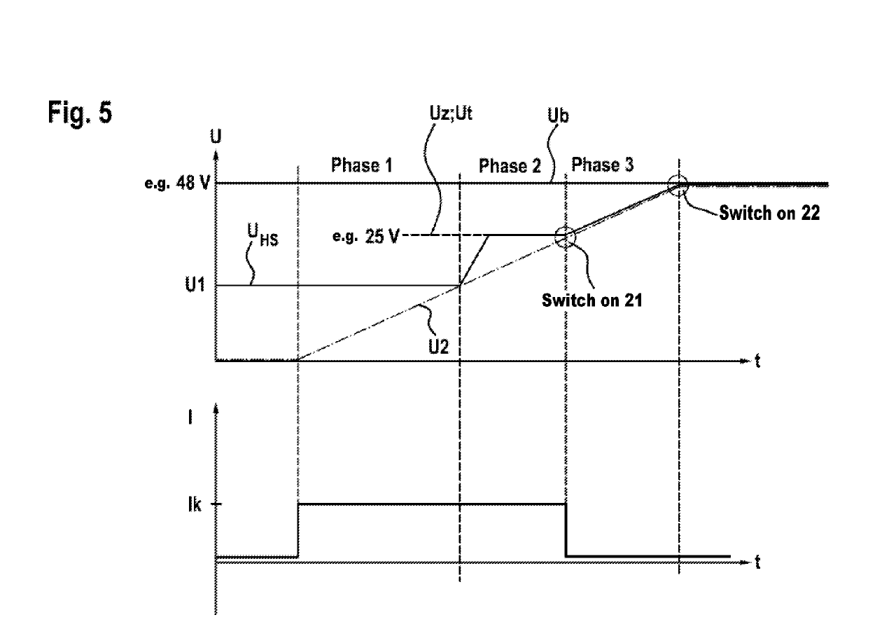

The circuitry of the charging means 18 for charging the intermediate circuit capacitance 20 of the second onboard power supply system 14 forms the essential core of the invention and is to be explained below by means of a typical ramp-up scenario as shown in FIG. 5.

In the quiescent state of the system, the two protective elements 21, 22 and the switch 30 for the energy storage 38 of the second onboard power supply system 14 are open. The second onboard power supply system 14 is thus de-energized.

When the system starts, the second protective element 22 of the DC-DC converter 10 is initially closed in order to connect the DC-DC converter 10 to ground 24. In the next step, before closing the switch 30, the voltage level in the second onboard power supply system 14 must be adapted to the open-circuit voltage of the energy storage 38 of the second onboard power supply system 14, so that no current spikes occur when connecting the energy storage 38 to the existing capacitances 20 of the components 34 connected in the second onboard power supply system 14 (the sum of the capacitances of these components forms the intermediate circuit capacitance 20). Adding the circuitry of the charging means 18 for charging the intermediate circuit capacitance 20 of the second onboard power supply system 14 makes it possible to achieve the function of a switchable constant-current source.

Charging the intermediate circuit capacitance 20 is divided into three phases, as shown in FIG. 5:

Phase 1: Activating the first switching means 26 causes the charging means acting as a constant-current source 18 to be switched on. A constant current Ik flows. This current flows via the intrinsic diode of the upper MOSFET of the first protective element 21 via the terminal KL 60 into the second onboard power supply system 14.

As a result, the second onboard power supply system voltage U2 and the voltage at the intermediate circuit capacitance 20 increase from 0 V to close to the first onboard power supply system voltage U1 (for example, 12 V, voltage at KL30), thus charging the intermediate circuit capacitance 20. The first protective element 21 remains open. The voltage U_{HS} at the output HS of the DC-DC converter 10 remains constant at the voltage level of the first onboard power supply system voltage U1 of, for example, 12 V. The switch from phase 1 to phase 2 occurs after the voltage of the second onboard power supply system U2 approaches the voltage U_{HS} at the output HS of the DC-DC converter 10.

Phase 2: The DC-DC converter 10 is put into operation while the first protective element 21 is still open, and the voltage U_{HS} at the output HS of the DC-DC converter 10 is ramped up in a controlled manner up to an intermediate voltage Uz of, for example, approximately 25 V. To do this, the voltage U_{HS} is for example increased linearly until the intermediate voltage Uz is reached. The voltage U_{HS} then remains at the level of the intermediate voltage Uz. The constant current source of the charging means 18 remains switched on so that the voltage at the intermediate circuit capacitance 20 or the second onboard power supply system voltage U2 is slowly carried along. Phase 2 ends when the second onboard power supply system voltage U2 reaches the voltage U_{HS} remaining at the level of the intermediate voltage Uz. With the aid of the charging means 18, the voltage level of the second onboard power supply system voltage U2 has now been raised above that of the first onboard power supply system voltage U1. The DC-DC converter 10 can thus be used directly for further increasing the voltage of the second onboard power supply system voltage U2, since the primary voltage is now no longer below the secondary voltage of the DC-DC converter 10. The charging means 18 thus acts in a targeted manner to achieve the desired voltage increase of the second onboard power supply system voltage U2 in connection with the intermediate circuit capacitance 20, which acts as a voltage storage. If necessary, an additional component would have to be provided to provide a suitable voltage storage in the second onboard power supply system 14.

Phase 3: When the voltage U_{HS} at the output HS and the second onboard power supply system voltage U2 have converged, the first protective circuit 21 is closed. The constant-current source of the charging means 18 is also simultaneously switched off. The DC-DC converter 10 is now in active reverse operation. It increases the second onboard power supply system voltage U2 to the open-circuit voltage Ub of the energy storage 38 by charging the intermediate circuit capacitance 20. When the open-circuit voltage Ub of the energy storage 38 of the second onboard power supply system 14 and the second onboard power supply system voltage U2 have reached the same level (end of phase 3), the switch 30 of the energy storage 38 can be closed without problems. The system is now ready for operation.

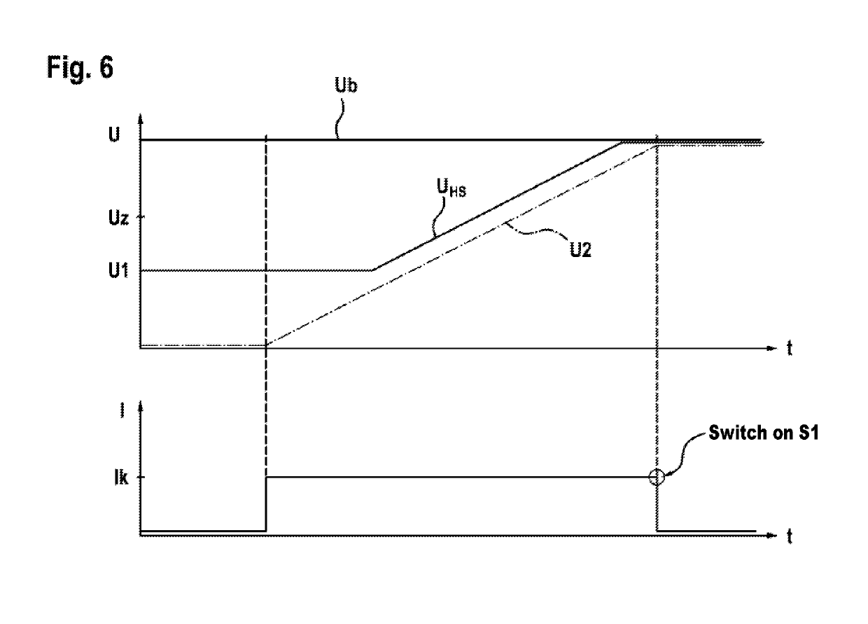

The alternative charging method according to FIG. 6 differs from that of FIG. 5 in that the charging means 18 also remains activated when the intermediate voltage Uz of, for example, slightly over 25 V is reached. As of this point in time, the charging means 18 and the DC-DC converter 10 charge the intermediate circuit capacitance 20 in parallel. After the second onboard power supply system voltage U2 at the intermediate circuit capacitance 20 has reached the open-circuit voltage Ub of the energy storage 38, the switch 30 and thus the energy storage 38 can be activated.

It is essential that a multistage charging concept is implemented. In the first phase, the intermediate circuit capacitance 20 of the second onboard power supply system 14 is charged to an intermediate voltage Uz. The intermediate voltage Uz is chosen such that the DC-DC converter 10 is capable of further charging the intermediate circuit capacitance 20 starting from this intermediate voltage Uz. If the intermediate voltage Uz that is close to the first onboard power supply system voltage U1 at terminal KL30 has been reached, the DC-DC converter 10 is activated. As of this instant, the voltage U_{HS} at the output of the DC-DC converter 10 is raised further in a controlled manner, for example, as a ramp. Blocked by the intrinsic diode of the lower MOSFET of the first protection means 21, the current delivered to the terminal HS by the DC-DC converter 10 flows into the charging means 18, and, limited to the charging current Ik of the charging means 18, flows via the intrinsic diode of the upper MOSFET and the terminal KL60 into the second onboard power supply system 14.

Since the constant-current source 18 remains switched on, the voltage at the intermediate circuit capacitance 20, the second onboard power supply system voltage U2, is slowly carried along. If the voltage U2 at the intermediate circuit capacitance 20 reaches the voltage U_{HS} at the DC-DC converter 10, the first protective element 21 or its switching means can be closed, that is, both MOSFETs can be switched to conducting in order to connect the terminal HS and the terminal KL60. It is thus ensured that no compensating currents or only very small compensating currents flow. According to FIG. 5, the constant-current source 18 is now switched off. The DC-DC converter 10 is in active reverse operation and increases the second onboard power supply system voltage U2 to the open-circuit voltage Ub of the energy storage 38 in the second onboard power supply system 14. When the second onboard power supply system voltage U2 and the open-circuit voltage Ub are equal, the energy storage 38 can be connected to the second onboard power supply system 14 by closing the switch 30. The system is now ready for normal operation.

Alternatively, in the embodiment according to FIG. 5, the second onboard power supply system voltage U2 could already be raised to the target voltage Ub, instead of the intermediate voltage Uz. Phase 3 would then be omitted.

This multistage activation is especially preferably suitable, since it is possible to draw on the monitoring functionality of the DC-DC converter 10 that is already available during the additional voltage increase of the second onboard power supply system voltage U2. Here, the voltage, the current, or even the voltage rise at the output HS of the DC-DC converter 10 could be monitored and if necessary also be used for a fault diagnosis and protective function.

The described method also provides the option of performing a diagnosis of the intermediate circuit during charging via the charging means.

It is thus possible to determine whether a short circuit to ground exists or leakage currents exist. In addition, it is possible to determine which capacitance 20 is present in the intermediate circuit. A diagnosis of the entire second onboard power supply system is also possible, for example, by evaluating the voltage profile and/or current profile in the intermediate circuit. To do this, the second onboard power supply system voltage U2 in the intermediate circuit could be increased in a targeted manner to a known, non-critical voltage Ut of, for example, 20 V. In addition, all or only certain control devices and components in the second onboard power supply system 14 are polled via corresponding bus systems as to whether they are also measuring the non-critical voltage Ut of, for example, 20 V. Only then is the second onboard power supply system voltage U2 increased further and the second onboard power supply system 14 activated. The non-critical voltage Ut could possibly also coincide with the intermediate voltage Uz.

Onboard power supply system architectures of this kind normally use bidirectional reactor step-down converters as DC-DC converters 10 because of their low circuit complexity and efficiency advantages, as indicated schematically in FIG. 4. An n-phase DC-DC converter 10 could be used having n reactors that are sequentially activated, each of which is bidirectionally controllable via two switching means. However, the use of the apparatus and method is not limited to this. As a matter of principle, the reactor step-down converter can transfer energy only from a higher voltage level (primary side) to a lower voltage level (secondary side). In the case of a bidirectional reactor step-down converter, it is alternatively possible to convert energy in reverse operation from the lower voltage level on the secondary side to a higher voltage level on the primary side. However, the primary voltage can never be lower than the secondary voltage under any circumstances. This is reliably achieved by providing the charging means 18, 18′.

If the potential at terminal KL60 (second onboard power supply system voltage U2) falls below the potential of terminal KL30 (first onboard power supply system voltage U1) of the DC-DC converter 10, an intrinsic diode of an upper half-bridge transistor, which is not shown in detail, becomes conductive, so that an uncontrolled current flow from KL30 to KL60 between the two onboard power supply systems 12, 14 would arise. In order to prevent this current flow, the first protective element 21 in the terminal KL60 circuit of the DC-DC converter 10 is required, which, for example, can be implemented as a relay or inverse-parallel semiconductor switch. The switching element is normally used as a back-to-back combination of two inverse-parallel semiconductor switches, which provides the additional option of preventing an uncontrolled current flow between the two onboard power supply systems 12, 14 (from terminal KL60 to terminal KL30) in the event of a short circuit of the first switching means 26.

When the vehicle is in its quiescent state, the second onboard power supply system 14 is disconnected from the energy storage 38 of the second onboard power supply system 14 for reasons of safety by opening the switch 30 and is thus de-energized. Before reconnecting this energy storage 38, because of the intermediate circuit capacitances 20 present in the second onboard power supply system 14 (for example, intermediate circuit capacitance 20 of the generator 34), the second onboard power supply system voltage U2 must first be raised in a controlled manner before the switch 30 is closed.

Also when using a bidirectional reactor step-down converter 10 in connection with a double-layer capacitor DLC (at a higher voltage level), for example, in the onboard power supply system from FIG. 2, it is necessary to charge the capacitor 15 starting from 0 V (completely discharged) (examples: initial operation, resuming operation of the vehicle after a longer standing phase with the starter battery 32 disconnected). Since the reactor converter (here: reverse operation, stepping up only) is not capable of doing this, the described charging means 18 can also be provided for charging the capacitor 15 from the voltage of 0 V to above the first onboard power supply system voltage U1.

The objective of the apparatus and method is to use simple switching measures to enable the DC-DC converter 10, for example, configured as a bidirectional reactor step-down converter, to charge the energy storage 32 on the primary side in reverse operation (secondary side to primary side) even if the voltage on the primary side is lower than the secondary voltage. In this case, necessary additional measures can be omitted in other components, thus achieving cost advantages.

The apparatus and method are in particular suitable for connecting multiple-voltage onboard power supply systems 12, 14 of motor vehicles, since they increasingly use high-power consumers. However, use is not limited to this.

1. An apparatus for connecting multiple-voltage onboard power supply systems, comprising at least one DC-DC converter (10) configured to connect a first onboard power supply system (12) having a first onboard power supply system voltage (U1) to a second onboard power supply system (14) having a second onboard power supply system voltage (U2), characterized in that at least one charger (18) is provided for increasing the second onboard power supply system voltage (U2) before connecting an energy storage (38) for supplying the second onboard power supply system (14).

2. The apparatus as claimed in claim 1, characterized in that the charger (18) increases the second onboard power supply system voltage (U2) by charging an intermediate circuit capacitance (20) that is present in the second onboard power supply system (14).

3. The apparatus as claimed in claim 1, characterized in that the charger (18) increases the second onboard power supply system voltage (U2) at least to an intermediate voltage (Uz), at which time the DC-DC converter (10) is connected for further increasing the voltage of the second onboard power supply system voltage (U2).

4. The apparatus as claimed in claim 1, characterized in that at least one protective element (21) is arranged between the DC-DC converter (10) and the second onboard power supply system (14).

5. The apparatus as claimed in claim 1, characterized in that the charger (18) at least partially supplies a charging current (Ik) to the second onboard power supply system (14) via the protective element (21).

6. The apparatus as claimed in claim 1, characterized in that the protective element (21) is closed if the second onboard power supply system voltage (U2) approximately reaches the voltage (U_{HS}) at the output (HS) of the DC-DC converter (10), which can be connected to the second onboard power supply system (14).

7. The apparatus as claimed in claim 1, characterized in that a switch (30) is provided via which an energy storage (38) connected to the second onboard power supply system (14) if the second onboard power supply system voltage (U2) approximately corresponds to an open-circuit voltage (Ub) of the energy storage (38).

8. A method for connecting multiple-voltage onboard power supply systems, comprising at least one DC-DC converter (10) that is configured to connect a first onboard power supply system (12) having a first onboard power supply system voltage (U1) to a second onboard power supply system (14) having a second onboard power supply system voltage (U2), characterized in that at least one charger (18) increases the second onboard power supply system voltage (U2) before connecting an energy storage (38) for supplying the second onboard power supply system (14).

9. The method as claimed in claim 8, characterized in that the charger (18) charges an intermediate circuit capacitance (20) that is present in the second onboard power supply system (14) in order to increase the second onboard power supply system voltage (U2).

10. The method as claimed in claim 8, characterized in that the second onboard power supply system voltage (U2), upon reaching an intermediate voltage (Uz) that is larger than the first onboard power supply system voltage (U1), continues to be increased via the DC-DC converter (10) and the charger (18).

11. The method as claimed in claim 8, characterized in that the charger (18) increases the second onboard power supply system voltage (U2) to a specified voltage (Ut), at which time at least one consumer (34) connected to the second onboard power supply system (14).

12. The method as claimed in claim 8, characterized in that at least one protective element (21) located between the second onboard power supply system (14) and the DC-DC converter (10) is activated if a voltage (U_{HS}) at an output (HS) of the DC-DC converter (10), that can be connected to the second onboard power supply system (14), corresponds approximately to the second onboard power supply system voltage (U2).

13. The method as claimed in claim 8, characterized in that the charger (18) is deactivated if a voltage (U_{HS}) at an output (HS) of the DC-DC converter (10), that can be connected to the second onboard power supply system (14), corresponds approximately to the second onboard power supply system voltage (U2).

14. The method as claimed in claim 8, characterized in that the second onboard power supply system voltage (U2) is increased to an open-circuit voltage (Ub) of an energy storage (38), that can be connected to the second onboard power supply system (14), via the DC-DC converter (10) and the charger (18).

15. The method as claimed in claim 8, characterized in that the energy storage (38) is connected to the second onboard power supply system (14) if the second onboard power supply system voltage (U2) corresponds approximately to the open-circuit voltage (Ub) of the energy storage (38).

16. The apparatus as claimed in claim 4, wherein the at least one protective element (21) is two semiconductor switches that are connected inversely parallel to each other.

17. The method as claimed in claim 8, characterized in that the second onboard power supply system voltage (U2), upon reaching an intermediate voltage (Uz) that is larger than the first onboard power supply system voltage (U1), continues to be increased via the DC-DC converter (10).

18. The method as claimed in claim 8, characterized in that the second onboard power supply system voltage (U2), upon reaching an intermediate voltage (Uz) that is larger than the first onboard power supply system voltage (U1), continues to be increased via the charger (18).

19. The method as claimed in claim 8, characterized in that the charger (18) increases the second onboard power supply system voltage (U2) to a specified voltage (Ut), at which time the second onboard power supply system (14) is checked for proper operation.

20. The method as claimed in claim 8, characterized in that the second onboard power supply system voltage (U2) is increased to an open-circuit voltage (Ub) of an energy storage (38), that can be connected to the second onboard power supply system (14), via the DC-DC converter (10).

21. The method as claimed in claim 8, characterized in that the second onboard power supply system voltage (U2) is increased to an open-circuit voltage (Ub) of an energy storage (38), that can be connected to the second onboard power supply system (14), via the charger (18).
